(19) United States
(12) Patent Application Publication
(10) Pub. No.: US 2016/0306434 A1
(43) Pub. Date: Oct. 20, 2016

(54) Method for interacting with mobile or wearable device

(71) Applicant: 16Lab Inc, Kamakura (JP)

(72) Inventor: RAFAEL FERRIN, Yokohama (JP)

(73) Assignee: 16Lab Inc, Kamakura (JP)

(21) Appl. No.: 15/133,894

(22) Filed: Apr. 20, 2016

Related U.S. Application Data
(60) Provisional application No. 62/149,712, filed on Apr. 20, 2015.

(51) Int. Cl. G06F 3/01; G06F 3/0346; G06F 3/038; G06K 9/00

(52) U.S. Cl. CPC G06F 3/017; G06K 9/00355; G06F 3/0346; G06F 3/0383; G06F 2203/0384

(57) ABSTRACT

Methods for instant, secure and easy to use interaction with a mobile or wearable device are disclosed. The method provides high recognition accuracy and enables implementation of numerous gestures.

### PRIORITY

This application claims priority of U.S. provisional application No. 62/149,712 filed on Apr. 20, 2015, and the content of which is incorporated herein by reference.

### FIELD OF THE INVENTION

The present invention relates to the field of mobile and wearable devices, more specifically to the field of methods of interacting with mobile or wearable devices.

### BACKGROUND OF THE INVENTION

Prior art uses principles, wherein a trigger is activated, following which a stream of data is acquired from different sensors within a device, and this data is then used as input data for a decision algorithm resulting in a decision being made.

For example, if the user moves the device from left to right, then one command or mode within the device is switched on, and when the user moves the device in a circle another command or mode is switched on within the device.

These types of control methods are very limited due to the nature of the decision algorithm, which defines the limits of the possible gestures, the recognition accuracy, and creates limitations to the interaction with the mobile or wearable device.

### SUMMARY OF THE INVENTION

The aim of the present invention is to provide an instant, secure and easy-to-use method for interacting with a mobile or wearable device which would have higher recognition accuracy and enable to implement more gestures. It has been conceived for implementation in handheld and mobile devices (for example smartphones, remote controls, tablets, wands, and other hand held and mobile devices), preferably in wearable miniature devices (for example smart jewelry, smart watches, smart wristbands, smart rings, or other smart devices such as electronic devices connected to other devices or networks via different protocols such as, but not limited to Bluetooth, NFC, WiFi, 3G, that can operate to some extent interactively and autonomously).

The aim is achieved by the method according to the present invention by analyzing the data, depending on the initial pose, wherein the data is a gesture or a command and starts a different algorithm depending on that. According to the present method the initial pose triggers process depending on the initial pose detected, and the rest of the received data is analyzed in many different ways.

In contrast with known solutions the present method enables the possibility of combining defined interactions of a different nature, including gestures, continuous interpretation of data (virtual mouse, 2D pointer, pedometer), gradual regulation of a parameter (light, volume, timer), and detection of certain data (pulse detection, fall detection) among others.

Regarding the present invention, when a trigger is activated the initial values of the data from the sensors are used as decision criteria to start different functionalities. That set of values is hereinafter referred to as ‘pose’ or ‘initial pose’. Data then streamed by the sensors is used in different ways (or discarded) depending on the purpose of the detected initial pose. Different sensors work in different ways, and depending on the initial pose the method ignores some sensors or changes the frequency of the data acquisition.

It is an object of this invention to provide a method for interacting with mobile or wearable devices using sensor data as input data comprising a configuration phase, a predefining phase and a usage phase, wherein the predefining phase comprises following steps: predefining a set of initial poses of the device; and predefining functionalities associated with the initial poses; and the usage phase comprises following steps: adopting an initial pose for a desired functionality; activating a trigger; acquiring data from sensors; using the first values of the data to detect the initial pose; determining the functionality according to the initial pose; formatting the data (if required) for that functionality; and interpreting the rest of the input data stream according to that functionality

### BRIEF DESCRIPTION OF THE DRAWINGS

The preferred embodiment of present invention is explained more precisely with references to figures added, where

FIG. 1 illustrates the prior art where the user moves the device from left to right, then one command or mode within the device is switched on;

FIG. 2 illustrates the prior art shown on FIG. 1 when the user moves the device in a circle another command or mode is switched on within the device;

FIG. 3 illustrates the prior art showing that the initial pose is used inside of the same method that is going to recognize the rest of the data as a gesture;

FIG. 4 illustrates the method according to the present invention and explains the difference of the state of the art with the present invention;

FIG. 5 and FIG. 6 illustrate example orientations of the mobile or wearable device in which the method according to present invention is implemented.

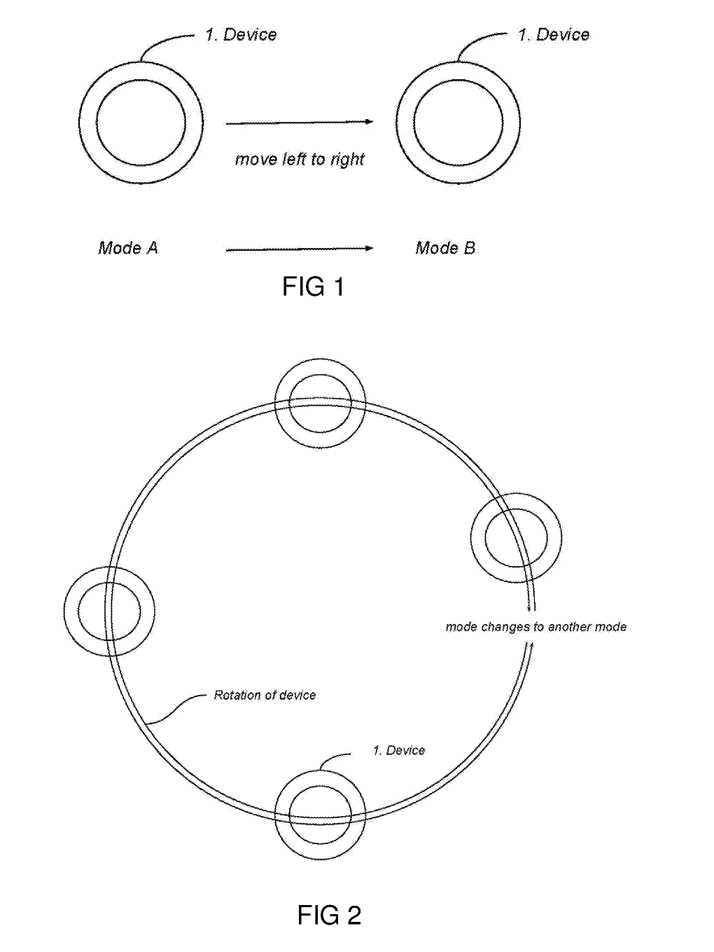

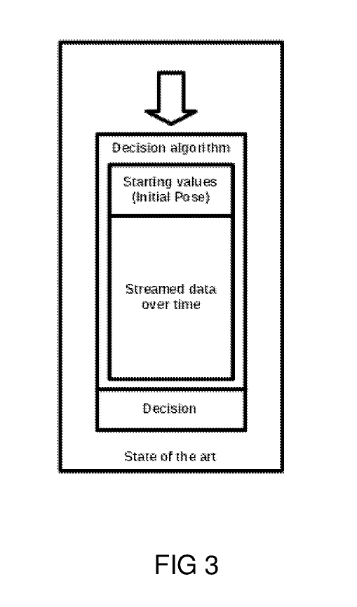

### DETAILED DESCRIPTION OF THE INVENTION

The present method for interacting with a mobile or wearable device using a stream of data of any nature comprises the following steps;

<configuration>
predefining the set of initial poses of the device;
predefining the functionalities associated to those initial poses;
<usage>
adopting the initial pose for the desired functionality
activating the trigger
acquiring data from the sensors
using the first values of the data to detect the initial pose
determining the functionality according to the initial pose
formatting the data (if required) for that functionality
interpreting the rest of the input data stream according to that functionality

The nature of the data used in the present invention could be for example IMU (Inertial Measurement Unit), camera, linear and/or angular accelerometer, magnetometer, gyroscope, color sensor, electrostatic field sensor, tilt sensor, GPS, backlight, clock, battery level, status of a short link radio technology (such as Bluetooth®) -connection or any other quantifiable parameter measuring unit related to the mobile or wearable device use or their combination. The data could be generated by the device itself or it can be received in any way.

The definition of the initial poses comprises direct data values (such as battery level, orientation of the device, etc.) and/or data derived from the direct data values (for example orientation changes fast: the device is being shaken or GPS coordinates change fast: user is travelling). Therefore, some of the values of an initial pose are inputs from the user (e.g. orientation, shaking) and others are circumstantial. The ones chosen (i.e. the sources of data that the user can manipulate (for example, not the battery level or the detection of some BLE signals)) by the user are key to the present invention, because they give the user the ability to select an initial pose (shake the device, put it vertical, etc.) before activating the trigger. As the user knows the possible initial poses, the selection of a pose is equivalent to the selection of a command to the device (type this letter, create a mouse pointer on the screen, switch off the TV,etc.).

The activation trigger may be a button on the device, a software function, the moment data starts streaming or any other method, function or command initiated either by the user, and/or by the device itself and/or an external interaction, or any combination thereof.

One complimentary advantage of this invention is that for many data sources such as IMU (Inertial Measurement Unit) or color sensors, for example, it is not necessary to have previous formatting of the sensor data to be used as part of the initial pose. For example, an accelerometer providing raw acceleration data over the X axis will differ depending on the hardware and configuration, so for similar orientations it will have similar values, yet during a shaking movement it will oscillate considerably. Therefore, both orientation and stability can be used as an initial pose without formatting. Depending on the selected functionality after the initial pose the data could be specifically filtered or formatted for the selected functionality.

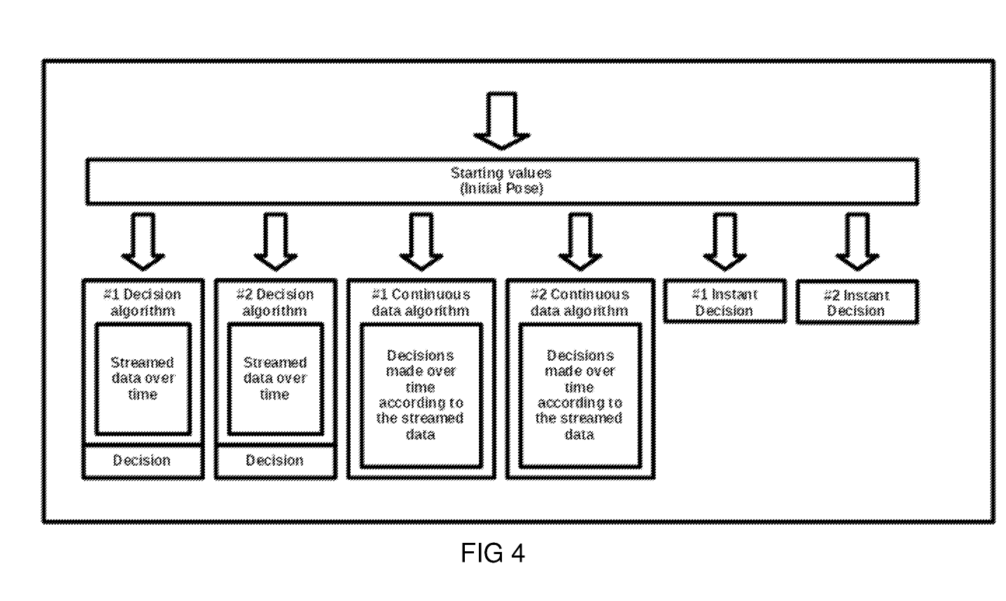

FIG. 4 illustrates the method according to the present invention and explains the difference of the state of the art with the present invention wherein each of the columns is an alternative embodiment of the method according to the present invention. Algorithm or command and the starting value determine which one of the alternative embodiments is executed.

FIG. 4 shows how the starting values (Initial pose) are considered beforehand for selecting which of the possible steps will be used for analyzing the rest of the data. Depending on that direction, in one embodiment a direct command is executed (Example: Initial pose: device is shaking when trigger is activated, and there is an incoming call>>Instant command triggered: mute that incoming phone call) or in another embodiment of the present method the device decides to use the rest of the data as a continuous data streaming to emulate for example a mouse device, or manipulate a volume.

The prior art discloses methods where the received data and an action is interconnected -the decision of the algorithm that it is going to analyze the data is made before the data starts. In the present method the data is received first and then an action is made. The present method makes the starting values the key to determine the meaning of the incoming data and how to analyze it.

The last of the three embodiments of the present methods on FIG. 4 is gesture based wherein the data is received, a gesture is recognized and once the gesture is recognized, a command is executed.

As an example embodiment of the present invention, a device with at least one button using an accelerometer and proximity sensor could define these poses, wherein the pose initiates a command to execute functionality:

1. Pseudo-static vertical orientation=control TV using gesture recognition
2. Pseudo-static upside-down orientation=continuous analysis as mouse pointer
3. Pseudo-static landscape orientation=type by using gesture recognition
4. Shaking with proximity off=cancel previous command
5. Shaking with proximity on=mute notifications
6. <others>.

In the above example the 1st and 3rd poses could use the same gesture recognition procedure to recognize for example the letter “x”, but the present invention makes the following distinction: depending on the starting orientation of the device when the button is pressed, it will either type an “x” or it will switch off the TV, for example. Meanwhile, if the 4th pose is detected when the button is pressed, the rest of the data could be ignored without need of any gesture recognition.

It is also important to note the difference between continuous data interpretation as in the 2nd pose in the above example compared with close gesture recognition: The analysis of the data in both cases is completely different and the present invention is making it possible to easily and instantly integrate both procedures together.

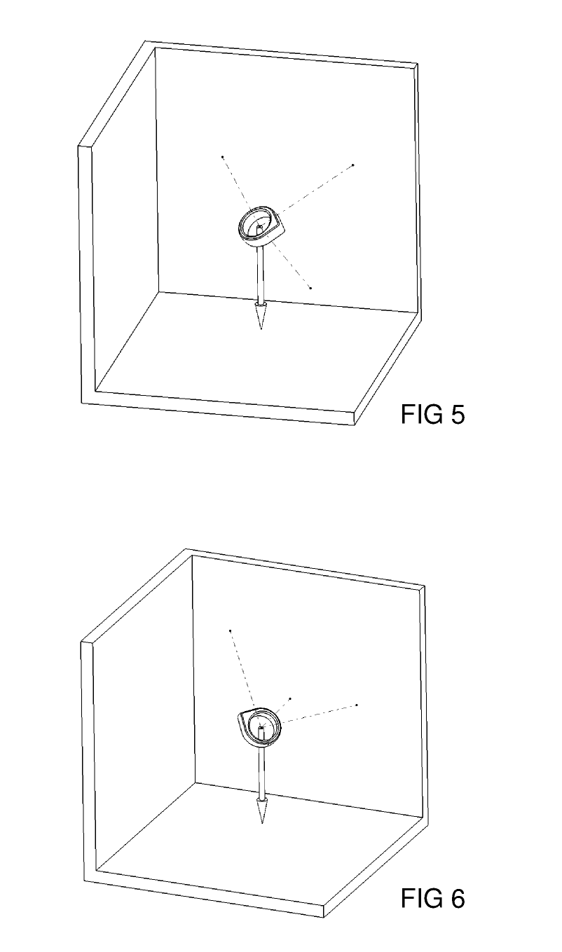

FIG. 5 and FIG. 6 illustrate example orientations of the mobile (for example smartphone) or wearable device (for example smart ring) in which the method according to present invention is implemented.

For example, to reject a call, shake the phone with the screen pointing down. To answer, shake the phone with the screen pointing up. To mute the phone, turn the screen upside-downside several times, etc. In these cases, the fact that the phone is receiving a call is one of the starting values of the initial pose. More specifically, it is one of the values that the user cannot manipulate, for example the battery level or Wi-Fi connections.

What is claimed is:

1. A method for interacting with mobile or wearable devices using sensor data as input data comprising a configuration phase, a predefining phase and a usage phase,
wherein the predefining phase comprises following steps:
predefining a set of initial poses of the device; and
predefining functionalities associated with the initial poses;
and
the usage phase comprises following steps:
adopting an initial pose for a desired functionality;
activating a trigger;
acquiring data from sensors;
using first values of the data to detect the initial pose;
determining the functionality according to the initial pose;
optionally formatting the data for the functionality; and
interpreting the rest of the input data stream according to the functionality.

2. The method according to claim 1, wherein the initial pose comprises direct data values selected from the group consisting of battery level, orientation of the device, WiFi-connection, status of a Bluetooth connection, or any other quantifiable parameter measuring unit related to the mobile or wearable device use or their combination.

3. The method according to claim 1, wherein the values of the initial pose are calculated from data derived from direct data values selected from the group consisting of speed of the orientation change, and speed of GPS coordinates change.

4. The method according to claim 1, wherein the values of the initial pose are inputs from a user initiated by orientation of the device.

5. The method according to claim 1, wherein the values of the initial pose are inputs from a user initiated by shaking the device.

6. The method according to claim 1, wherein acquiring input data comprises numeric values representing quantifiable parameters related to mobile device use.

7. The method according to claim 1, wherein the rest of the input data is managed by different functions.

8. The method according to claim 1, wherein the rest of the input data is managed by the same function but with different parameters.

9. The method according to claim 1, wherein the rest of the input data is ignored.

10. The method according to claim 1, wherein the rest of the input data is managed by any other method.

11. The method according to claim 1, wherein the trigger activation is a physical button on the device.

12. The method according to claim 1, wherein the trigger activation is a digital button on the device.

13. The method according to claim 1, wherein the trigger activation is a function.

14. The method according to claim 1, wherein the trigger activation is a command initiated by the user.

15. The method according to claim 1, wherein the trigger activation is a function or command initiated by the device itself.

16. The method according to claim 1, wherein the trigger activation is a function or command initiated by an external interaction.

17. The method according to claim 1, wherein the trigger activation is a function or command initiated by the starting moment of a data streaming.
